(19) United States
(12) Patent Application Publication
(10) Pub. No.: US 2023/0325637 A1
(43) Pub. Date: Oct. 12, 2023

(54) METHOD FOR DETERMINING QUANTITY OF CALCIUM LINE FED INTO MOLTEN STEEL BASED ON MINIMUM GIBBS FREE ENERGY PRINCIPLE

(71) Applicants: North China University of Technology, Beijing (CN); University of Science and Technology Beijing, Beijing (CN)

(72) Inventors: Lifeng Zhang, Beijing (CN); Weijian Wang, Beijing (CN); Ying Ren, Beijing (CN); Jujin Wang, Beijing (CN); Binyu Lyu, Beijing (CN)

(21) Appl. No.: 18/128,015

(22) Filed: Mar. 29, 2023

(30) Foreign Application Priority Data
Apr. 7, 2022 (CN) 202210364271X

(51) Int. Cl. G06N 3/045; C21C 7/00

(52) U.S. Cl. CPC G06N 3/045; C21C 7/0006

(57) ABSTRACT

Provided is a method for determining a quantity of a calcium line fed into molten steel based on a minimum Gibbs free energy principle, which relates to an calcium treatment process of molten steel refining for iron and steel metallurgy. The method includes: establishing a connection with a database to read composition information and a temperature of the molten steel in an actual production process; calculating contents of inclusions in the molten steel according to the read composition information; calculating a required quantity of calcium of the molten steel to control the inclusions in a target area under a current condition; and calculating a length of the fed calcium line according to parameter information of the calcium treatment process and the required quantity of calcium of the molten steel. With the method, a scientific and reasonable guidance is provided for the calcium treatment process in the actual production process.

### TECHNICAL FIELD

The present disclosure relates to the field of molten steel refining for iron and steel metallurgy, and in particularly, to a method for determining a quantity of a calcium line fed into molten steel based on a minimum Gibbs free energy principle.

### DESCRIPTION OF RELATED ART

In a smelting process of molten steel, aluminum, as a strong deoxidizer, can effectively reduce oxygen in the molten steel to a lower level. However, due to the addition of the aluminum, a large number of alumina inclusions will be produced, which will lead to nozzle clogging, affect smooth running of a continuous casting process and lead to a reduced quality of the product. Therefore, for most steel grades that use the aluminum for deoxidation, calcium, which is more active than the aluminum, is usually added to the molten steel to modify the alumina inclusions in the molten steel into liquid calcium aluminate, thereby reducing problem of nozzle clogging, and thus ensuring the smooth running of the continuous casting process and improving the quality of the product. Further, the existence of the calcium in the molten steel can also control morphology and quantity of manganese sulfide (MnS) inclusions during solidification, cooling and heating process. However, there is a reasonable range of a required quantity of calcium in the molten steel, which cannot be too high or too low.

A reasonable required quantity of calcium in the molten steel is related to conditions of the molten steel such as a temperature, a composition, and a type thereof. The required quantity of calcium in the molten steel is different for different production heats. At present, almost all calcium treatment process in enterprises are based on experience, and lack a scientific and reasonable guidance, so the control of calcium content in steel is unstable. Therefore, in the present disclosure, composition of inclusions and an appropriate calcium content in the molten steel are calculated based on a minimum Gibbs free energy principle, and an appropriate length of a fed calcium line is finally obtained, thereby realizing the precise control of a calcium treatment process, which is of great research value and significance on reducing production and operation costs of enterprises, improving product quality and alloy utilization efficiency.

### SUMMARY

In order to at least solve the shortcomings of the related art, the present disclosure provides method for determining a quantity of a calcium line fed into molten steel based on a minimum Gibbs free energy principle to realize precise control of a calcium treatment process.

Specifically, a method for determining a quantity of a calcium line fed into molten steel based on a minimum Gibbs free energy principle is provided according an embodiment of the present disclosure, which includes:

S1, obtaining, from a factory database, composition information of the molten steel before a calcium treatment process and parameter information of the calcium treatment process;

S2, performing thermodynamic calculation on the composition information of the molten steel based on the minimum Gibbs free energy principle to obtain contents of inclusions in the molten steel and a required quantity of calcium of the molten steel, specifically including:

S21, calculating a minimum Gibbs free energy of the molten steel based on the minimum Gibbs free energy principle using a formula (1) expressed as follows:

$$\begin{matrix}min . {G}_{s} = {\sum }_{i = 1}^{c} {n}_{i} {G}_{i} = {\sum }_{i = 1}^{c} {n}_{i} ( {G}_{m , i}^{Θ} + RT ln {a}_{i} ) \\ = {n}_{m} [ {G}_{m}^{Θ} + RT ln ( {a}_{m} ) ] + {n}_{s l a g} [ {G}_{slag}^{Θ} + RT ln ( {a}_{slag} ) ] + {n}_{s o l i d} \times {G}_{s o l i d}^{Θ}\end{matrix} \qquad ( 1 )$$

where min.Gₛ represents the minimum Gibbs free energy of the molten steel, Gᵢ^{Θ} represents a standard molar Gibbs free energy of a composition i of the molten steel, aᵢ represents an activity value of the composition i, the composition i includes a solid-phase inclusion, a liquid-phase inclusion and a liquid-phase steel, m represents elements of the liquid-phase steel (i.e., the elements dissolved in the liquid-phase steel), n represents a number of moles, R represents a gas constant, T represents a temperature of the molten steel, slag represents the liquid-phase inclusion of the molten steel, solid is the solid-phase inclusion of the molten steel, and c represents the number of compositions of the molten steel; and

S22, calculating Gibbs free energies of the solid-phase inclusion, the liquid-phase inclusion and the liquid-phase steel,
where the Gibbs free energy of the solid-phase inclusion is calculated based on a formula (2) expressed as follows:

min.G_{Solid}=n_{Solid}G_{Solid}^{Θ}=n_{Al}_{₂}_{O}_{₃}G^{Θ}_{Al}_{₂}_{O}_{₃}+n_{CaO·6Al}_{₂}_{O}_{₃}G_{CaO·6Al}_{₂}_{O}_{₃}^{Θ}+n_{CaO·2Al}_{₂}_{O}_{₃}G_{CaO·2Al}_{₂}_{O}_{₃}^{Θ}+n_{CaO}G_{CaO}^{Θ}+n_{CaS}G_{CaS}^{Θ} (2)

where the Gibbs free energy of the liquid-phase inclusion is calculated based on a formula (3) expressed as follows:

min.G_{slag}=n_{Al}_{₂}_{O}_{₃}[G_{Al}_{₂}_{O}_{₃}^{Θ}+RT _ln(a_{Al}_{₂}_{O}_{₃})]+n_{CaO}[G_{CaO}⁷³ +RT ln(a_{CaO})] (3)

where the Gibbs free energy of the liquid-phase steel is calculated based on a formula (4) expressed as follows:

$$min . {G}_{F e} = {\sum }_{i = 1}^{C} {n}_{i} {G}_{i} = {\sum }_{i = 1}^{C} {n}_{i} ( {G}_{m , i}^{Θ} + RT ln {a}_{i} ) = {n}_{A l} [ {G}_{A l}^{Θ} + RT ln ( {x}_{A l} {γ}_{A l} ) ] + {n}_{Ca} [ {G}_{Ca}^{Θ} + RT ln ( {x}_{Ca} {γ}_{Ca} ) ] + {n}_{O} [ {G}_{O}^{Θ} + RT ln ( {x}_{O} {γ}_{O} ) ] + {n}_{S} [ {G}_{S}^{Θ} + RT ln ( {x}_{S} {γ}_{S} ) ] \qquad ( 4 )$$

where C represents the number of the elements of the liquid-phase steel, x represents a molar fraction of the elements in the liquid-phase steel, and γ represents an activity coefficient of the elements in the liquid-phase steel;

S23, calculating activity values of compositions of the solid-phase inclusion and activity values of compositions of the liquid-phase inclusion, where each of the activity values of the compositions of the solid-phase inclusion is 1, and the activity values of the compositions of the liquid-phase inclusion is calculated based on formulas (5) and (6) expressed as follows:

a_{Al}_{₂}_{O}_{₃}=(−3.9367*m_{Al}_{₂}_{O}_{₃}⁴+8.1721*m_{Al}_{₂}_{O}_{₃}³−3.7817*m_{Al}_{₂}_{O}_{₃}²+0.57821*m_{Al}_{₂}_{O}_{₃}−0.0145 (5)

a_{CaO}=(−6.4181*m_{Al}_{₂}_{O}_{₃}⁴+13.8441*m_{Al}_{₂}_{O}_{₃}³−8.1761*m_{Al}_{₂}_{O}_{₃}²+0.2823*m_{Al}_{₂}_{O}_{₃}+1.0129 (6)

where a_{Al}_{₂}_{O}_{₃} represents an activity value of a composition Al₂O₃ of the liquid-phase inclusion, a_{CaO} represents an activity value of a composition CaO of the liquid-phase inclusion, m_{Al}_{₂}_{O}_{₃} represents a mass fraction of the composition Al₂O₃ of the liquid-phase inclusion; and

S24, determining the contents of the inclusions in the molten steel, by substituting the formulas (2) to (6) into the formula (1), adding a constraint condition, in which an input variable is the composition information of the molten steel when the contents of the inclusions in the molten steel are calculated, and solving the substituted formula (1); and determining the required quantity of the calcium of the molten steel on a condition that the inclusions in the molten steel are controlled in a liquid phase region;

S3, predicting a yield rate of the calcium during the calcium treatment process;

S4, determining a length of the fed calcium line according to the required quantity of calcium of the molten steel, the yield rate of the calcium, and the parameter information of the calcium treatment process,
where the length of the fed calcium line is calculated based on a formula (7) expressed as follows:

$$L = \frac{W \times ( {n [ Ca ]}_{T} - {n [ Ca ]}_{O} ) \times {M}_{C a}}{η \times β \times μ \times {M}_{F e}} \qquad ( 7 )$$

where L represents the length of the fed calcium line with a unit of meter; W represents a weight of the molten steel with a unit of ton; n[Ca]_{T} represents the required quantity of calcium of the molten steel with a unit of %; n[Ca]₀ represents a calcium content of the molten steel before the calcium treatment process with a unit of %; M_{ca} represents a molar mass of calcium with a unit of gram per mole (g/mol); M_{Fe} is represents a molar mass of iron with a unit of g/mol; η represents the yield rate of the calcium with a unit of %; β represents a content of calcium of the calcium line with a unit of %; and μ represents a weight per meter of the calcium line with a unit of gram per meter (g/m).

Preferably, the constraint condition is expressed by formulas (8)-(11) as follows:

Σn_{Ca}=n_{[Ca]}+n_{CaO}+n_{CaS}+n_{CA}_{₂}+n_{CA6} (8)

Σn_{Al}=n_{[Al]}+2n_{Al}_{₂}_{O}_{₃}+4n_{CA}_{₂}+12n_{CA6} (9)

Σn_{O}=n_{[O]}+3n_{Al}_{₂}_{O}_{₃}+7n_{CA}_{₂}+19n_{CA6}+n_{CaO} (10)

Σn_{S}=n_{[S]}+n_{CaS} (11)

where Σn_{Ca} represents a total number of moles of calcium in the molten steel, n_{[Ca]} represents a number of moles of dissolved calcium in the liquid-phase steel, n_{[Al]} represents a number of moles of dissolved aluminum in the liquid-phase steel, n_{[O]} represents a number of moles of dissolved oxygen in the liquid-phase steel, n_{[S]} represents a number of moles of dissolved sulfur in the liquid-phase steel, n_{CaO} represents a number of moles of CaO in the inclusions, n_{CaS} represents a number of moles of CaS in the inclusions, n_{Al}_{₂}_{O}_{₃} represents a number of moles of Al₂O₃ in the inclusions, n_{CA}_{₆} represents a number of moles of CaO·6Al₂O₃ in the inclusions, and n_{CA2} represents the number of moles of CaO·2Al₂O₃ in the inclusions.

Preferably, the parameter information of the calcium treatment process includes: a content of Carbon (C) of the molten steel, a content of Silicon (Si) of the molten steel, a content of Manganese (Mn) of the molten steel, a content of Phosphorus (P) of the molten steel, a content of Sulphur (S) of the molten steel, a content of Calcium (Ca) of the molten steel, a content of Aluminum (Al) of the molten steel, a total content of oxygen in the molten steel, a content of dissolved oxygen in the liquid-phase steel, the temperature of the molten steel, the weight per meter of the calcium line, the content of calcium of the calcium line, and the weight of the molten steel.

Preferably, the predicting the yield rate of the calcium during the calcium treatment process includes:
predicting the yield rate of the calcium according to a neural network model or a content of dissolved oxygen in the liquid-phase steel.

Predicting the yield rate of the calcium according to the content of dissolved oxygen in the liquid-phase steel is expressed as a formula (12) as follows:

y=50000*xₒ+10 (12)

where xₒ represents the content of dissolved oxygen in the liquid-phase steel, and y represents the yield rate of the calcium predicted according to the content of dissolved oxygen in the liquid-phase steel.

Preferably, the neural network model is one of a shallow neural network model and a deep neural network model.

Compared with the related art, the present disclosure has at least the following beneficial effects.

For a method for determining a quantity of a calcium line fed into molten steel based on a minimum Gibbs free energy principle of the present disclosure, composition information of the molten steel and parameter information of the calcium treatment process for each heat are obtained, to predict contents of inclusions in the molten steel and a required quantity of calcium of the molten steel, and an appropriate quantity of a calcium line fed into the molten steel is obtained by combining the parameter information of the calcium treatment process such as a content of the calcium, a weight per meter of the calcium line, and a yield rate with the contents of the inclusions in the molten steel and required quantity of calcium of the molten steel. In the present disclosure, the contents of the inclusions in the molten steel is calculated based on a Gibbs free energy minimum principle, and the appropriate length of the fed calcium line in calcium treatment process is calculated, which can realize scientific and reasonable guidance for the calcium treatment operation, reduce the error caused by calcium feeding based on experience, facilitate stabilize a calcium treatment operation process, ensure smooth production of enterprises, reduce production costs and improve production efficiency and product quality.

### BRIEF DESCRIPTION OF THE DRAWINGS

FIG. 1 illustrates an overall flow diagram of the present disclosure.

FIG. 2 illustrates a schematic flow chart of a method for determining feed quantity of a calcium line into molten steel based on a minimum Gibbs free energy principle according to an embodiment of the present disclosure.

FIG. 3 illustrates a schematic flow chart for calculating a composition of inclusions in steel using a minimum Gibbs free energy principle according to an embodiment of the present disclosure.

FIG. 4 illustrates a schematic view of the influence of a calcium content in steel on inclusions calculated based on the minimum Gibbs free energy principle according to an embodiment of the present disclosure.

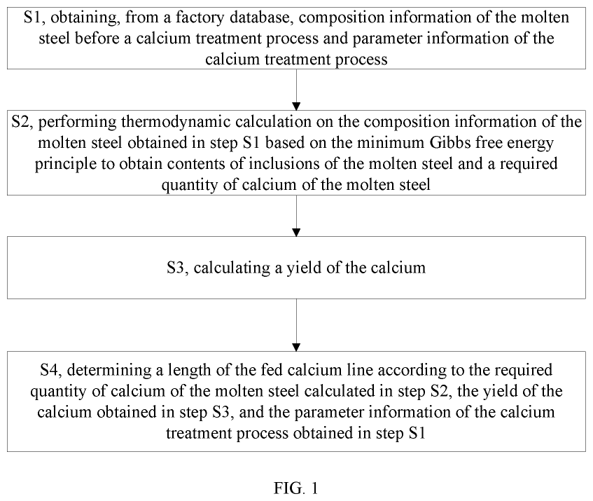

### DETAILED DESCRIPTION OF EMBODIMENTS

Exemplary embodiments, features and aspects of the present disclosure will be described in detail below combined with accompanying drawings. The same reference numerals in the accompanying drawings indicate elements with the same or similar functions. Although various aspects of the embodiments are shown in the accompanying drawings, the accompanying drawings are not necessarily drawn to scale unless otherwise specified.

An embodiment of the present disclosure provides a method for determining a quantity of a calcium line fed into molten steel based on a minimum Gibbs free energy principle, which includes:

S1, obtaining, from a factory database, composition information of the molten steel before a calcium treatment process and parameter information of the calcium treatment process;

S2, performing thermodynamic calculation on the composition information of the molten steel based on the minimum Gibbs free energy principle to obtain contents of inclusions in the molten steel and a required quantity of calcium of the molten steel, specifically including:

S21, calculating a minimum Gibbs free energy of the molten steel based on the minimum Gibbs free energy principle using a formula (1) expressed as follows:

$$\begin{matrix}min . {G}_{s} = {\sum }_{i = 1}^{c} {n}_{i} {G}_{i} = {\sum }_{i = 1}^{c} {n}_{i} ( {G}_{m , i}^{Θ} + RT ln {a}_{i} ) \\ = {n}_{m} [ {G}_{m}^{Θ} + RT ln ( {a}_{m} ) ] + {n}_{s l a g} [ {G}_{slag}^{Θ} + RT ln ( {a}_{slag} ) ] + {n}_{s o l i d} \times {G}_{s o l i d}^{Θ}\end{matrix} \qquad ( 1 )$$

where min.Gₛ represents the minimum Gibbs free energy of the molten steel, Gᵢ^{Θ} represents a standard molar Gibbs free energy of a composition i of the molten steel, aᵢ represents an activity value of the composition i, the composition i includes a solid-phase inclusion, a liquid-phase inclusion and a liquid-phase steel, m represents elements of the liquid-phase steel, n represents a number of moles, R represents a gas constant, T represents a temperature of the molten steel, slag represents the liquid-phase inclusion of the molten steel, solid is the solid-phase inclusion of the molten steel, and c represents the number of compositions of the molten steel; and

S22, calculating Gibbs free energies of the solid-phase inclusion, the liquid-phase inclusion and the liquid-phase steel,
where the Gibbs free energy of the solid-phase inclusion is calculated based on a formula (2) expressed as follows:

min.G_{Solid}=n_{Solid}G_{Solid}^{Θ}=n_{Al}_{₂}_{O}_{₃}G_{Al}_{₂}_{O}_{₃}^{Θ}+n_{CaO·6Al}_{₂}_{O}_{₃}G_{CaO·6Al}_{₂}_{O}_{₃}^{Θ}+n_{CaO·2Al}_{₂}_{O}_{₃}G_{CaO·2Al}_{₂}_{O}_{₃}^{Θ}+n_{CaO}G_{CaO}^{Θ}+n_{CaS}G_{CaS}^{Θ} (2)

where the Gibbs free energy of the liquid-phase inclusion is calculated based on a formula (3) expressed as follows:

min.G_{slag}=n_{Al}_{₂}_{O}_{₃}[G_{Al}_{₂}_{O}_{₃}^{Θ}+RT ln(a_{Al}_{₂}_{O}_{₃})]n_{CaO}[G_{CaO}⁷³ +RT ln(a_{CaO})] (3)

where the Gibbs free energy of the liquid-phase steel is calculated based on a formula (4) expressed as follows:

$$min . {G}_{F e} = {\sum }_{i = 1}^{C} {n}_{i} {G}_{i} = {\sum }_{i = 1}^{C} {n}_{i} ( {G}_{m , i}^{Θ} + RT ln {a}_{i} ) = {n}_{A l} [ {G}_{A l}^{Θ} + RT ln ( {x}_{A l} {γ}_{A l} ) ] + {n}_{Ca} [ {G}_{Ca}^{Θ} + RT ln ( {x}_{Ca} {γ}_{Ca} ) ] + {n}_{O} [ {G}_{O}^{Θ} + RT ln ( {x}_{O} {γ}_{O} ) ] + {n}_{S} [ {G}_{S}^{Θ} + RT ln ( {x}_{S} {γ}_{S} ) ] \qquad ( 4 )$$

where C represents the number of the elements of the liquid-phase steel, x represents a molar fraction of the elements in the liquid-phase steel, and γ represents an activity coefficient of the elements in the liquid-phase steel;

S23, calculating activity values of compositions of the solid-phase inclusion and activity values of compositions of the liquid-phase inclusion, where each of the activity values of the compositions of the solid-phase inclusion is 1, and the activity values of the compositions of the liquid-phase inclusion is calculated based on formulas (5) and (6) expressed as follows:

a_{Al}_{₂}_{O}_{₃}=(−3.9367*m_{Al}_{₂}_{O}_{₃}⁴+8.1721*m_{Al}_{₂}_{O}_{₃}³−3.7817*m_{Al}_{₂}_{O}_{₃}²+0.57821*m_{Al}_{₂}_{O}_{₃}−0.0145 (5)

a_{CaO}=(−6.4181*m_{Al}_{₂}_{O}_{₃}⁴+13.8441*m_{Al}_{₂}_{O}_{₃}³−8.1761*m_{Al}_{₂}_{O}_{₃}²+0.2823*m_{Al}_{₂}_{O}_{₃}+1.0129 (6)

where a_{Al}_{₂}_{O}_{₃} represents an activity value of a composition Al₂O₃ of the liquid-phase inclusion, a_{CaO} represents an activity value of a composition CaO of the liquid-phase inclusion, m_{Al}_{₂}_{O}_{₃} represents a mass fraction of the composition Al₂O₃ of the liquid-phase inclusion; and

S24, determining the contents of the inclusions in the molten steel, by substituting the formulas (2) to (6) into the formula (1), adding a constraint condition, in which an input variable is the composition information of the molten steel when the contents of the inclusions in the molten steel are calculated, and solving the substituted formula (1); and determining the required quantity of the calcium of the molten steel on a condition that the inclusions in the molten steel are controlled in a liquid phase region;

S3, predicting a yield rate of the calcium during the calcium treatment process; and

S4, determining a length of the fed calcium line according to the required quantity of calcium of the molten steel, the yield rate of the calcium, and the parameter information of the calcium treatment process,
where the length of the fed calcium line is calculated based on a formula (7) expressed as follows:

$$L = \frac{W \times ( {n [ Ca ]}_{T} - {n [ Ca ]}_{O} ) \times {M}_{C a}}{η \times β \times μ \times {M}_{F e}} \qquad ( 7 )$$

where L represents the length of the fed calcium line with a unit of meter; W represents a weight of the molten steel with a unit of ton; n[Ca]_{T} represents the required quantity of calcium of the molten steel with a unit of %; n[Ca]₀ represents a calcium content of the molten steel before the calcium treatment process with a unit of %; M_{Ca} represents a molar mass of calcium with a unit of gram per mole (g/mol); M_{Fe} is represents a molar mass of iron with a unit of g/mol; η represents the yield rate of the calcium with a unit of %; β represents a content of calcium of the calcium line with a unit of %; and μ represents a weight per meter of the calcium line with a unit of gram per meter (g/m).

In an illustrated embodiment, the constraint condition is expressed by formulas (8)-(11) as follows:

Σn_{Ca}=n_{[Ca]}+n_{CaO}+n_{CaS}+n_{CA}_{₂}+n_{CA6} (8)

Σn_{Al}=n_{[Al]}+2n_{Al}_{₂}_{O}_{₃}+4n_{CA}_{₂}+12n_{CA6} (9)

Σn_{O}=n_{[O]}+3n_{Al}_{₂}_{O}_{₃}+7n_{CA}_{₂}+19n_{CA6}+n_{CaO} (10)

Σn_{S}=n_{[S]}+n_{CaS} (11)

where Σn_{Ca} represents a total number of moles of calcium in the molten steel, n_{[Ca]} represents a number of moles of dissolved calcium in the liquid-phase steel, n_{[Al]} represents a number of moles of dissolved aluminum in the liquid-phase steel, n_{[O]} represents a number of moles of dissolved oxygen in the liquid-phase steel, n_{[S]} represents a number of moles of dissolved sulfur in the liquid-phase steel, n_{CaO} represents a number of moles of CaO in the inclusions, n_{CaS} represents a number of moles of CaS in the inclusions, n_{Al}_{₂}_{O}_{₃} represents a number of moles of Al₂O₃ in the inclusions, n_{CA}_{₆} represents a number of moles of CaO·6Al₂O₃ in the inclusions, and n_{CA2} represents the number of moles of CaO·2Al₂O₃ in the inclusions.

In an illustrated embodiment, the parameter information of the calcium treatment process includes: a content of Carbon (C) of the molten steel, a content of Silicon (Si) of the molten steel, a content of Manganese (Mn) of the molten steel, a content of Phosphorus (P) of the molten steel, a content of Sulphur (S) of the molten steel, a content of Calcium (Ca) of the molten steel, a content of Aluminum (Al) of the molten steel, a total content of oxygen in the molten steel, a content of dissolved oxygen in liquid-phase steel, the temperature of the molten steel, the weight per meter of the calcium line, the content of calcium of the calcium line, and the weight of the molten steel.

In an illustrated embodiment, the predicting the yield rate of the calcium during the calcium treatment process includes:
predicting the yield rate of the calcium according to a neural network model or a content of dissolved oxygen in the liquid-phase steel;
where predicting the yield rate of the calcium according to the content of dissolved oxygen in the liquid-phase steel is expressed as a formula (12) as follows:

y=50000*xₒ+10 (12)

where xₒ represents the content of dissolved oxygen in the liquid-phase steel, and y represents the yield rate of the calcium predicted according to the content of dissolved oxygen in the liquid-phase steel.

Further, the method may include feeding the calcium line with the length into the molten steel.

In the actual calculation process, the yield rate of the calcium can also be predicted and calculated by a prediction method of the yield rate of the calcium during the calcium treatment process based on a deep neural network previously applied by the applicant, which is not repeated herein.

### First Embodiment

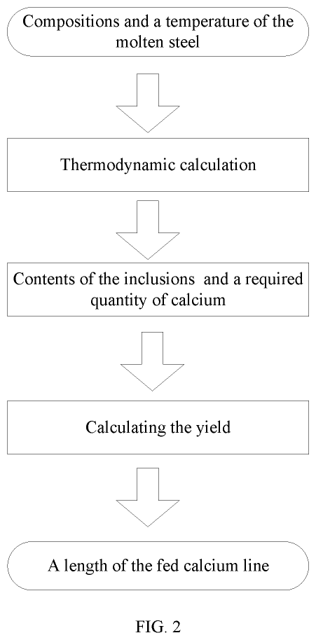

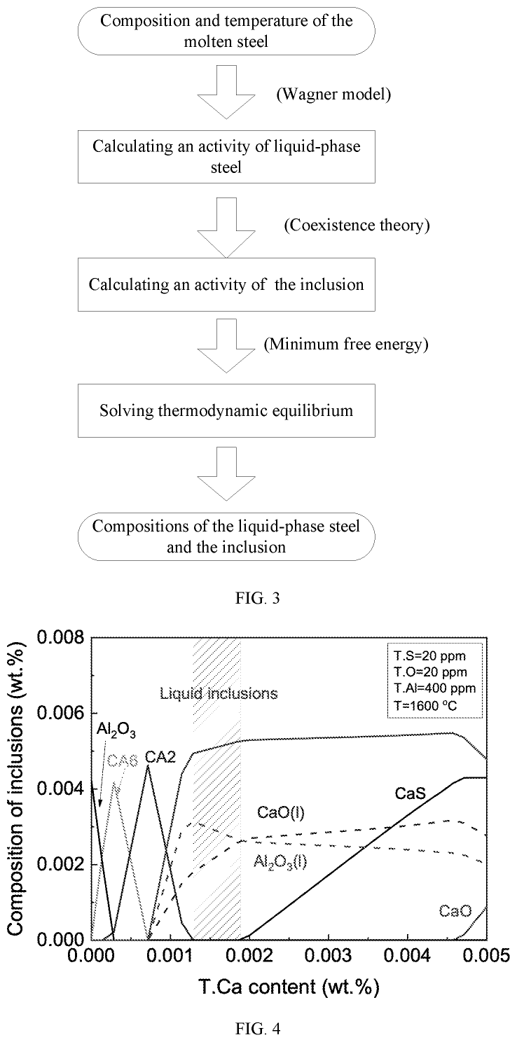

Referring to FIGS. 2 and 3, a method for determining a quantity of a calcium line fed into molten steel based on a minimum Gibbs free energy principle includes following steps S1 to S4:

S1, establishing a connection with a factory database to obtain composition information of the molten steel before a calcium treatment process and parameter information of the calcium treatment process: C=0.06%, Si=0.08%, Mn=1.4%, P=0.002%, S=0.0035%, Ca=0.0021%, Al=0.083%, T.O=0.007%, which represents a total content of oxygen in the molten steel consisting of an content of oxygen in a liquid-phase inclusion of the molten steel and an content of oxygen in dissolved liquid-phase steel, [O]=0.0003%, which represents the content of dissolved oxygen in liquid-phase steel , a temperature of the molten steel T=1873K, a weight per meter of the calcium line being 200 g/m, a content of calcium of the calcium line being 40%, and a weight of the molten steel being 100 t;
S2, performing thermodynamic calculation on the composition information of the molten steel obtained in step S1 based on the minimum Gibbs free energy principle to obtain contents of inclusions in the molten steel and a required quantity of calcium of the molten steel;
S3, predicting a yield rate of the calcium during the calcium treatment process; and
S4, determining a length of the fed calcium line according to the required quantity of calcium of the molten steel calculated in step S2, the yield rate of the calcium obtained in step S3, and the parameter information of the calcium treatment process obtained in step S1.

Further, in the step S2, a minimum Gibbs free energy of the molten steel is calculated based on the minimum Gibbs free energy principle using a formula (1) expressed as follows:

$$\begin{matrix}min . {G}_{s} = {\sum }_{i = 1}^{c} {n}_{i} {G}_{i} = {\sum }_{i = 1}^{c} {n}_{i} ( {G}_{m , i}^{Θ} + RT ln {a}_{i} ) \\ = {n}_{m} [ {G}_{m}^{Θ} + RT ln ( {a}_{m} ) ] + {n}_{s l a g} [ {G}_{slag}^{Θ} + RT ln ( {a}_{slag} ) ] + {n}_{s o l i d} \times {G}_{s o l i d}^{Θ}\end{matrix} \qquad ( 1 )$$

where min.G_{S} represents the minimum Gibbs free energy of the molten steel, Gᵢ^{Θ} represents a standard molar Gibbs free energy of a composition i of the molten steel, in which used data is shown in table 1, aᵢ represents an activity value of the composition i, the composition i includes a solid-phase inclusion, a liquid-phase inclusion and a liquid-phase steel.

TABLE 1
Standard molar Gibbs free energies of
the compositions of the molten steel

| Compositions of the molten steel | G_{m, i}^{Θ} (J · mol⁻¹) |
|---|---|
| Al | −116510 |
| O | −92146 |
| Ca | −150683 |
| S | −79068 |
| Al₂O₃ | −1974037 |
| CaO | −799279 |
| CaS | −577916 |
| CaO•6Al₂O₃ | −12728232 |
| CaO•2Al₂O₃ | −4821505 |

The Gibbs free energy of the solid-phase inclusion is calculated based on a formula (2) expressed as follows:

min.G_{Solid}=n_{Solid}G_{Solid}^{Θ}=n_{Al}_{₂}_{O}_{₃}G_{Al}_{₂}_{O}_{₃}^{Θ}+n_{Ca6}G_{CA6}^{Θ}+n_{CA2}G_{CA2}^{Θ}+n_{CaO}G_{CaO}^{Θ}+n_{CaS}G_{CaS}^{Θ} (2)

The Gibbs free energy of the liquid-phase inclusion is calculated based on a formula (3) expressed as follows:

min.G_{slag}=n_{Al}_{₂}_{O}_{₃}[G_{Al}_{₂}_{O}_{₃}+RT ln(a_{Al}_{₂}_{O}_{₃})]n_{CaO}[G_{CaO}⁷³ +RT ln(a_{CaO})] (3)

The Gibbs free energy of the liquid-phase steel is calculated based on a formula (4) expressed as follows:

$$min . {G}_{F e} = {\sum }_{i = 1}^{C} {n}_{i} {G}_{i} = {\sum }_{i = 1}^{C} {n}_{i} ( {G}_{m , i}^{Θ} + RT ln {a}_{i} ) = {n}_{A l} [ {G}_{A l}^{Θ} + RT ln ( {x}_{A l} {γ}_{A l} ) ] + {n}_{Ca} [ {G}_{Ca}^{Θ} + RT ln ( {x}_{Ca} {γ}_{Ca} ) ] + {n}_{O} [ {G}_{O}^{Θ} + RT ln ( {x}_{O} {γ}_{O} ) ] + {n}_{S} [ {G}_{S}^{Θ} + RT ln ( {x}_{S} {γ}_{S} ) ] . \qquad ( 4 )$$

Further, each of the activity values of the compositions of the solid-phase inclusion is 1, and the activity values of the compositions of the liquid-phase inclusion is calculated based on formulas (5) and (6) expressed as follows:

a_{Al}_{₂}_{O}_{₃}=(−3.9367*m_{Al}_{₂}_{O}_{₃}⁴+8.1721*m_{Al}_{₂}_{O}_{₃}³−3.7817*m_{Al}_{₂}_{O}_{₃}²+0.57821*m_{Al}_{₂}_{O}_{₃}−0.0145 (5)

a_{CaO}=(−6.4181*m_{Al}_{₂}_{O}_{₃}⁴+13.8441*m_{Al}_{₂}_{O}_{₃}³−8.1761*m_{Al}_{₂}_{O}_{₃}²+0.2823*m_{Al}_{₂}_{O}_{₃}+1.0129 (6)

where a_{Al}_{₂}_{O}_{₃} represents an activity value of a composition Al₂O₃ of the liquid-phase inclusion, a_{CaO} represents an activity value of a composition CaO of the liquid-phase inclusion, m_{Al}_{₂}_{O}_{₃} represents a mass fraction of the composition Al₂O₃ of the liquid-phase inclusion.

In the step S2, the constraint condition is expressed by formulas (8)-(11) as follows:

Σn_{Ca}=n_{[Ca]}+n_{CaO}+n_{CaS}+n_{CA}_{₂}+n_{CA6} (8)

Σn_{Al}=n_{[Al]}+2n_{Al}_{₂}_{O}_{₃}+4n_{CA}_{₂}+12n_{CA6} (9)

Σn_{O}=n_{[O]}+3n_{Al}_{₂}_{O}_{₃}+7n_{CA}_{₂}+19n_{CA6}+n_{CaO} (10)

Σn_{S}=n_{[S]}+n_{CaS} (11)

where Σn_{Ca} represents a total number of moles of calcium in the molten steel, n_{[Ca]} represents a number of moles of dissolved calcium in the liquid-phase steel, n_{[Al]} represents a number of moles of dissolved aluminum in the liquid-phase steel, n_{[O]} represents a number of moles of dissolved oxygen in the liquid-phase steel, n_{[S]} represents a number of moles of dissolved sulfur in the liquid-phase steel, n_{CaO} represents a number of moles of CaO in the inclusions, n_{CaS} represents a number of moles of CaS in the inclusions, n_{Al}_{₂}_{O}_{₃} represents a number of moles of Al₂O₃ in the inclusions, n_{CA}_{₆} represents a number of moles of CaO·6Al₂O₃ in the inclusions, and n_{CA2} represents the number of moles of CaO·2Al₂O₃ in the inclusions.

The formulas (2) to (6) are substituted into the formula (1), and a solution of the formula (1) is found by MATLAB. It is found that the molten steel contains 0.0021% of CaO·6Al₂O₃ and 0.0024% of CaO·2Al₂O₃, and the required quantity of the calcium of the molten steel is in a range from 0.0018% to 0.0027% to control the inclusions in the liquid phase region.

Further, in the step S3, the predicting the yield rate of the calcium during the calcium treatment process includes:
predicting the yield rate of the calcium according to a neural network model or a content of dissolved oxygen in the liquid-phase steel;
where predicting the yield rate of the calcium according to the content of dissolved oxygen in the liquid-phase steel is expressed as a formula as follows:

y=50000*xₒ+10 (12)

where xₒ represents the content of dissolved oxygen in the liquid-phase steel, and y represents the yield rate η of the calcium predicted according to the content of dissolved oxygen in the liquid-phase steel.

The content of dissolved oxygen in the liquid-phase steel is 0.0003%, and the yield rate of the calcium predicted according to the content of dissolved oxygen in the liquid-phase steel is 25%.

Further, in the step S2, the calculated required quantity of the calcium of the molten steel is in a range from 0.0018% to 0.0027%, and the length of the fed calcium line is calculated based on a formula (7) expressed as follows:

$$L = \frac{W \times ( {n [ Ca ]}_{T} - {n [ Ca ]}_{O} ) \times {M}_{C a}}{η \times β \times μ \times {M}_{F e}} \qquad ( 7 )$$

where L represents the length of the fed calcium line with a unit of meter; W represents a weight of the molten steel with a unit of ton; n[Ca]_{T} represents the required quantity of calcium of the molten steel with a unit of %; n[Ca]₀ represents a calcium content of the molten steel before the calcium treatment process with a unit of %; M_{Ca} represents a molar mass of calcium with a unit of gram per mole (g/mol); M_{Fe} is represents a molar mass of iron with a unit of g/mol; η represents the yield rate of the calcium with a unit of %; β represents a content of calcium of the calcium line with a unit of %; and μ represents a weight per meter of the calcium line with a unit of gram per meter (g/m).

According to the formula (1), the calculated length of the fed calcium line is in a range from 40 m to 70 m.

### Second Embodiment

Referring to FIG. 2, a method for determining a quantity of a calcium line fed into molten steel based on a minimum Gibbs free energy principle includes following steps S1 to S4:

S1, establishing a connection with a factory database to obtain composition information of the molten steel before a calcium treatment process and parameter information of the calcium treatment process: C=0.06%, Si=0.08%, Mn=1.4%, P=0.002%, S=0.0035%, Ca=0.0020%, Al=0.083%, T.O=0.007%, which represents a total content of oxygen in the molten steel consisting of an content of dissolved oxygen in a liquid-phase inclusion of the molten steel and an content of oxygen in liquid-phase steel, [O]=0.0003%, which represents the content of dissolved oxygen in liquid-phase steel, a temperature of the molten steel T=1873K, a weight per meter of the calcium line being 200 g/m, a content of calcium of the calcium line being 40%, and a weight of the molten steel being 100 t;

S2, performing thermodynamic calculation on the composition information of the molten steel obtained in step S1 based on the minimum Gibbs free energy principle to obtain contents of an inclusions in the molten steel and a required quantity of calcium of the molten steel;

S3, predicting a yield rate of the calcium during the calcium treatment process; and

S4, determining a length of the fed calcium line according to the required quantity of calcium of the molten steel calculated in step S2, the yield rate of the calcium obtained in step S3, and the parameter information of the calcium treatment process obtained in step S1.

Further, in the step S2, a minimum Gibbs free energy of the molten steel is calculated based on the minimum Gibbs free energy principle using a formula (1) expressed as follows

$$min . {G}_{s} = {\sum }_{i = 1}^{c} {n}_{i} {G}_{i} = {\sum }_{i = 1}^{c} {n}_{i} ( {G}_{m , i}^{Θ} + RT ln {a}_{i} ) = {n}_{m} [ {G}_{metal}^{Θ} + RT ln ( {a}_{m} ) ] + {n}_{slag} [ {G}_{slag}^{Θ} + R T ln ( {a}_{slag} ) ] + {n}_{solid} \times {G}_{solid}^{Θ} \qquad ( 1 )$$

where min.Gₛ represents the minimum Gibbs free energy of the molten steel, Gᵢ^{Θ} represents a standard molar Gibbs free energy of a composition i of the molten steel, in which used data is shown in table 1, aᵢ represents an activity value of the composition i, the composition i includes a solid-phase inclusion, a liquid-phase inclusion and a liquid-phase steel.

TABLE 2
Standard molar Gibbs free energies of
the compositions of the molten steel

| Compositions of the molten steel | G_{m, i}^{Θ} (J · mol⁻¹) |
|---|---|
| Al | −116510 |
| O | −92146 |
| Ca | −150683 |
| S | −79068 |
| Al₂O₃ | −1974037 |
| CaO | −799279 |
| CaS | −577916 |
| CaO•6Al₂O₃ | −12728232 |
| CaO•2Al₂O₃ | −4821505 |

The Gibbs free energy of the solid-phase inclusion is calculated based on a formula (2) expressed as follows:

min.G_{Solid}=n_{Solid}G_{Solid}^{Θ}=n_{Al}_{₂}_{O}_{₃}G_{Al}_{₂}_{O}_{₃}^{Θ}+n_{Ca6}G_{Ca6}^{Θ}+n_{CA2}G_{CA2}^{Θ}+n_{CaO}G_{CaO}^{Θ}+n_{CaS}G_{CaS}^{Θ} (2)

The Gibbs free energy of the liquid-phase inclusion is calculated based on a formula (3) expressed as follows:

min.G_{slag}=n_{Al}_{₂}_{O}_{₃}[G_{Al}_{₂}_{O}_{₃}+RT ln(a_{Al}_{₂}_{O}_{₃})]n_{CaO}[G_{CaO}⁷³ +RT ln(a_{CaO})] (3)

The Gibbs free energy of the liquid-phase steel is calculated based on a formula (4) expressed as follows:

$$min . {G}_{F e} = {\sum }_{i = 1}^{C} {n}_{i} {G}_{i} = {\sum }_{i = 1}^{C} {n}_{i} ( {G}_{m , i}^{Θ} + RT ln {a}_{i} ) = {n}_{A l} [ {G}_{A l}^{Θ} + RT ln ( {x}_{A l} {γ}_{A l} ) ] + {n}_{Ca} [ {G}_{Ca}^{Θ} + RT ln ( {x}_{Ca} {γ}_{Ca} ) ] + {n}_{O} [ {G}_{O}^{Θ} + RT ln ( {x}_{O} {γ}_{O} ) ] + {n}_{S} [ {G}_{S}^{Θ} + RT ln ( {x}_{S} {γ}_{S} ) ] . \qquad ( 4 )$$

Further, each of the activity values of the compositions of the solid-phase inclusion is 1, and the activity values of the compositions of the liquid-phase inclusion is calculated based on formulas (5) and (6) expressed as follows:

a_{Al}_{₂}_{O}_{₃}=(−3.9367*m_{Al}_{₂}_{O}_{₃}⁴+8.1721*m_{Al}_{₂}_{O}_{₃}³−3.7817*m_{Al}_{₂}_{O}_{₃}²+0.57821*m_{Al}_{₂}_{O}_{₃}−0.0145 (5)

a_{CaO}=(−6.4181*m_{Al}_{₂}_{O}_{₃}⁴+13.8441*m_{Al}_{₂}_{O}_{₃}³−8.1761*m_{Al}_{₂}_{O}_{₃}²+0.2823*m_{Al}_{₂}_{O}_{₃}+1.0129 (6)

where a_{Al}_{₂}_{O}_{₃} represents an activity value of a composition Al₂O₃ of the liquid-phase inclusion, a_{CaO} represents an activity value of a composition CaO of the liquid-phase inclusion, m_{A}_{₂}_{O}_{₃} represents a mass fraction of the composition Al₂O₃ of the liquid-phase inclusion.

In the step S2, the constraint condition is expressed by formulas (8)-(11) as follows:

Σn_{Ca}=n_{[Ca]}+n_{CaO}+n_{CaS}+n_{CA}_{₂}+n_{CA6} (8)

Σn_{Al}=n_{[Al]}+2n_{Al}_{₂}_{O}_{₃}+4n_{CA}_{₂}+12n_{CA6} (9)

Σn_{O}=n_{[O]}+3n_{Al}_{₂}_{O}_{₃}+7n_{CA}_{₂}+19n_{CA6}+n_{CaO} (10)

Σn_{S}=n_{[S]}+n_{CaS} (11)

where Σn_{Ca} represents a total number of moles of calcium in the molten steel, n_{[Ca]} represents a number of moles of dissolved calcium in the liquid-phase steel, n_{[Al]} represents a number of moles of dissolved aluminum in the liquid-phase steel, n_{[O]} represents a number of moles of dissolved oxygen in the liquid-phase steel, n_{[S]} represents a number of moles of dissolved sulfur in the liquid-phase steel, n_{CaO} represents a number of moles of CaO in the inclusions, n_{CaS} represents a number of moles of CaS in the inclusions, n_{Al}_{₂}_{O}_{₃} represents a number of moles of Al₂O₃ in the inclusions, n_{CA}_{₆} represents a number of moles of CaO·6Al₂O₃ in the inclusions, and n_{CA2} represents the number of moles of CaO·2Al₂O₃ in the inclusions.

The formulas (2) to (6) are substituted into the formula (1), and a solution of the formula (1) is found by MATLAB. All the inclusions in the molten steel are liquid calcium aluminate, and the inclusions are controlled in a target area by the constraint condition. The required quantity of the calcium of the molten steel is in a range from 0.0018% to 0.0027%. FIG. 4 illustrates an influence of a content of calcium of the molten steel on the inclusions calculated according to the minimum Gibbs free energy principle.

Further, according to the calculation method of a content of calcium in the first embodiment, it is calculated that the content of calcium in the molten steel before the calcium treatment process is 0.002%, which is in a range from 0.0018% to 0.0027%, so the molten steel does not need to be fed with calcium, and a suitable length of a fed calcium line is 0 m.

Finally, it should be explained that the above-mentioned embodiments are only used to illustrate the technical solutions of the present disclosure, but not to limit thereto. Although the present disclosure has been described in detail with reference to the foregoing embodiments, it should be understood by those skilled in the art that the technical solutions described in the foregoing embodiments can still be modified, or some or all of the technical features of the foregoing embodiments can be replaced by equivalents thereof, and these modifications or substitutions do not make the essence of the corresponding technical solutions deviate from the scope of the technical solutions of the forgoing embodiments of the present disclosure.

What is claimed is:

1. A method for determining a quantity of a calcium line fed into molten steel based on a minimum Gibbs free energy principle, comprising:
S1, obtaining, from a factory database, composition information of the molten steel before a calcium treatment process and parameter information of the calcium treatment process;
S2, performing thermodynamic calculation on the composition information of the molten steel based on the minimum Gibbs free energy principle to obtain contents of inclusions in the molten steel and a required quantity of calcium of the molten steel, specifically comprising:
S21, calculating a minimum Gibbs free energy of the molten steel based on the minimum Gibbs free energy principle using a formula (1) expressed as follows:
$$min . {G}_{s} = {\sum }_{i = 1}^{c} {n}_{i} {G}_{i} = {\sum }_{i = 1}^{c} {n}_{i} ( {G}_{m , i}^{Θ} + RT ln {a}_{i} ) = {n}_{m} [ {G}_{m}^{Θ} + RT ln ( {a}_{m} ) ] + {n}_{s l a g} [ {G}_{slag}^{Θ} + RT ln ( {a}_{slag} ) ] + {n}_{s o l i d} \times {G}_{s o l i d}^{Θ} \qquad ( 1 )$$
where min.Gₛ represents the minimum Gibbs free energy of the molten steel, Gᵢ^{Θ} represents a standard molar Gibbs free energy of a composition i of the molten steel, aᵢ represents an activity value of the composition i, the composition i comprises a solid-phase inclusion, a liquid-phase inclusion and a liquid-phase steel, m represents elements of the liquid-phase steel, n represents a number of moles, R represents a gas constant, T represents a temperature of the molten steel, slag represents the liquid-phase inclusion of the molten steel, solid is the solid-phase inclusion of the molten steel, and c represents the number of compositions of the molten steel; and
S22, calculating Gibbs free energies of the solid-phase inclusion, the liquid-phase inclusion, and the liquid-phase steel,
where the Gibbs free energy of the solid-phase inclusion is calculated based on a formula (2) expressed as follows:
min.G_{Solid}=n_{Solid}G_{Solid}^{Θ}=n_{Al}_{₂}_{O}_{₃}G_{Al}_{₂}_{O}_{₃}^{Θ}+n_{CaO·6Al}_{₂}_{O}_{₃}G_{CaO·6Al}_{₂}_{O}_{₃}^{Θ}+n_{CaO·2Al}_{₂}_{O}_{₃}G_{CaO·2Al}_{₂}_{O}_{₃}^{Θ}+n_{CaO}G_{CaO}^{Θ}+n_{CaS}G_{CaS}^{Θ} (2)
where the Gibbs free energy of the liquid-phase inclusion is calculated based on a formula (3) expressed as follows:
min.G_{slag}=n_{Al}_{₂}_{O}_{₃}[G_{Al}_{₂}_{O}_{₃}+RT ln(a_{Al}_{₂}_{O}_{₃})]n_{CaO}[G_{CaO}⁷³ +RT ln(a_{CaO})] (3)
where the Gibbs free energy of the liquid-phase steel is calculated based on a formula (4) expressed as follows:
$$min . {G}_{F e} = {\sum }_{i = 1}^{C} {n}_{i} {G}_{i} = {\sum }_{i = 1}^{C} {n}_{i} ( {G}_{m , i}^{Θ} + RT ln {a}_{i} ) = {n}_{A l} [ {G}_{A l}^{Θ} + RT ln ( {x}_{A l} {γ}_{A l} ) ] + {n}_{Ca} [ {G}_{Ca}^{Θ} + RT ln ( {x}_{Ca} {γ}_{Ca} ) ] + {n}_{O} [ {G}_{O}^{Θ} + RT ln ( {x}_{O} {γ}_{O} ) ] + {n}_{S} [ {G}_{S}^{Θ} + RT ln ( {x}_{S} {γ}_{S} ) ] . \qquad ( 4 )$$
where C represents the number of the elements of the liquid-phase steel, x represents a molar fraction of the elements in the liquid-phase steel, and γ represents an activity coefficient of the elements in the liquid-phase steel;
S23, calculating activity values of compositions of the solid-phase inclusion and activity values of compositions of the liquid-phase inclusion, wherein each of the activity values of the compositions of the solid-phase inclusion is 1, and the activity values of the compositions of the liquid-phase inclusion is calculated based on formulas (5) and (6) expressed as follows:
a_{Al}_{₂}_{O}_{₃}=(−3.9367*m_{Al}_{₂}_{O}_{₃}⁴+8.1721*m_{Al}_{₂}_{O}_{₃}³−3.7817*m_{Al}_{₂}_{O}_{₃}²+0.57821*m_{Al}_{₂}_{O}_{₃}−0.0145 (5)
a_{CaO}=(−6.4181*m_{Al}_{₂}_{O}_{₃}⁴+13.8441*m_{Al}_{₂}_{O}_{₃}³−8.1761*m_{Al}_{₂}_{O}_{₃}²+0.2823*m_{Al}_{₂}_{O}_{₃}+1.0129 (6)
where a_{Al}_{₂}_{O}_{₃} represents an activity value of a composition Al₂O₃ of the liquid-phase inclusion, a_{CaO} represents an activity value of a composition CaO of the liquid-phase inclusion, m_{Al}_{₂}_{O}_{₃} represents a mass fraction of the composition Al₂O₃ of the liquid-phase inclusion; and
S24, determining the contents of the inclusions in the molten steel, by substituting the formulas (2) to (6) into the formula (1), adding a constraint condition, in which an input variable is the composition information of the molten steel when the contents of the inclusions in the molten steel are calculated, and solving the substituted formula (1); and determining the required quantity of the calcium of the molten steel on a condition that the inclusions in the molten steel are controlled in a liquid phase region;
S3, predicting a yield rate of the calcium during the calcium treatment process; and
S4, determining a length of the fed calcium line according to the required quantity of calcium of the molten steel, the yield rate of the calcium, and the parameter information of the calcium treatment process,
wherein the length of the fed calcium line is calculated based on a formula (7) expressed as follows:
$$L = \frac{W \times ( {n [ Ca ]}_{T} - {n [ Ca ]}_{O} ) \times {M}_{C a}}{η \times β \times μ \times {M}_{F e}} \qquad ( 7 )$$
where L represents the length of the fed calcium line with a unit of meter; W represents a weight of the molten steel with a unit of ton; n[Ca]_{T} represents the required quantity of calcium of the molten steel with a unit of %; n[Ca]₀ represents a calcium content of the molten steel before the calcium treatment process with a unit of %; M_{ca} represents a molar mass of calcium with a unit of gram per mole (g/mol); M_{Fe} is represents a molar mass of iron with a unit of g/mol; η represents the yield rate of the calcium with a unit of %; β represents a content of calcium of the calcium line with a unit of %; and μ represents a weight per meter of the calcium line with a unit of gram per meter (g/m).

2. The method for determining the quantity of the calcium line fed into molten steel based on the minimum Gibbs free energy principle according to claim 1, wherein the constraint condition is expressed by formulas (8)-(11) as follows:
Σn_{Ca}=n_{[Ca]}+n_{CaO}+n_{CaS}+n_{CA}_{₂}+n_{CA6} (8)
Σn_{Al}=n_{[Al]}+2n_{Al}_{₂}_{O}_{₃}+4n_{CA}_{₂}+12n_{CA6} (9)
Σn_{O}=n_{[O]}+3n_{Al}_{₂}_{O}_{₃}+7n_{CA}_{₂}+19n_{CA6}+n_{CaO} (10)
Σn_{S}=n_{[S]}+n_{CaS} (11)
where Σn_{Ca} represents a total number of moles of calcium in the molten steel, n_{[Ca]} represents a number of moles of dissolved calcium in the liquid-phase steel, n_{[Al]} represents a number of moles of dissolved aluminum in the liquid-phase steel, n_{[O]} represents a number of moles of dissolved oxygen in the liquid-phase steel, n_{[S]} represents a number of moles of dissolved sulfur in the liquid-phase steel, n_{CaO} represents a number of moles of CaO in the inclusions, n_{CaS} represents a number of moles of CaS in the inclusions, n_{Al}_{₂}_{O}_{₃} represents a number of moles of Al₂O₃ in the inclusions, n_{CA}_{₆} represents a number of moles of CaO·6Al₂O₃ in the inclusions, and n_{CA2} represents the number of moles of CaO·2Al₂O₃ in the inclusions.

3. The method for determining the quantity of the calcium line fed into molten steel based on the minimum Gibbs free energy principle according to claim 1, wherein the parameter information of the calcium treatment process comprises: a content of Carbon (C) of the molten steel, a content of Silicon (Si) of the molten steel, a content of Manganese (Mn) of the molten steel, a content of Phosphorus (P) of the molten steel, a content of Sulphur (S) of the molten steel, a content of Calcium (Ca) of the molten steel, a content of Aluminum (Al) of the molten steel, a total content of dissolved oxygen in the molten steel, a content of dissolved oxygen in the liquid-phase steel, the temperature of the molten steel, the weight per meter of the calcium line, the content of calcium of the calcium line, and the weight of the molten steel.

4. The method for determining the quantity of the calcium line fed into molten steel based on the minimum Gibbs free energy principle according to claim 1, wherein the predicting the yield rate of the calcium during the calcium treatment process comprises:
predicting the yield rate of the calcium according to one of a neural network model and a content of oxygen in the liquid-phase steel;
wherein predicting the yield rate of the calcium according to the content of dissolved oxygen in the liquid-phase steel is expressed as a formula (12) as follows:
y=50000*xₒ+10 (12)
where xₒ represents the content of dissolved oxygen in the liquid-phase steel, and y represents the yield rate of the calcium predicted according to the content of dissolved oxygen in the liquid-phase steel.

5. The method for determining the quantity of the calcium line fed into molten steel based on the minimum Gibbs free energy principle according to claim 4, wherein the neural network model is one of a shallow neural network model and a deep neural network model.
